(19) United States
(12) Patent Application Publication
(10) Pub. No.: US 2016/0319774 A1
(43) Pub. Date: Nov. 3, 2016

(54) Air Distributor for an Internal Combustion Engine

(71) Applicant: Mann+Hummel GMBH, Ludwigsburg (DE)

(72) Inventors: Marco Schweikart, Marbach (DE); Herbert Pietrowski, Pleidelsheim (DE)

(21) Appl. No.: 15/139,803

(22) Filed: Apr. 27, 2016

(30) Foreign Application Priority Data
Apr. 28, 2015 (DE) 102015005372.8

(51) Int. Cl. F02M 23/00; F02M 26/17; F02M 25/08

(52) U.S. Cl. CPC F02M 23/006; F02M 25/08; F02M 26/17

(57) ABSTRACT

An air distributor for an internal combustion engine is provided with at least two housing parts, wherein a flow channel for combustion air extends through the housing parts. An additional channel is provided that is formed by a gap between the housing parts and opens into the flow channel.

### BACKGROUND OF THE INVENTION

The invention relates to an air distributor for an internal combustion engine including at least two housing parts, wherein a flow channel for combustion air to be supplied extends in the air distributor and an additional channel for an additional gas opens into the flow channel.

In EP 2 330 278 A1 an air distributor is described for an internal combustion engine through which combustion air is supplied to the cylinder inlets of the internal combustion engine. The air distributor includes different housing parts of plastic material in which a flow channel for the combustion air to be supplied is extending. In the flow channel an adjustable throttle valve is arranged by means of which the free cross-section is adjustable for the air flow and, therefore, the volume stream is changeable.

The internal combustion engine is equipped with an exhaust gas recirculation whose recirculation line opens into the air distributor. For this purpose, in the air distributor an additional collection space is arranged which is formed in another housing part of the air distributor which is connected with the housing part provided with the flow channel. From the collection space the introduced exhaust gas can flow through a connecting passage into the flow channel for the combustion air of each cylinder inlet, wherein the connecting passage is introduced into the housing part with the flow channel.

### SUMMARY OF THE INVENTION

The invention has the object to provide an air distributor for an internal combustion engine with which through an additional channel an additional gaseous fluid can be introduced into the flow channel for the combustion air and that can be produced easily.

This object is solved according to the invention in that the additional channel is formed by a gap between two housing parts. The dependent claims provide expedient further embodiments.

The air distributor according to the invention can be used in internal combustion engines to supply combustion air to the cylinders of the internal combustion engine. The air distributor includes at least two housing parts and in at least one housing part a flow channel is formed for the combustion air to be supplied. The flow channel can be delimited, if necessary, by at least two housing parts of the air distributor. According to a preferred embodiment, the housing parts are made from plastic material. The housing parts are connected preferably fixedly with each other, in particular by welding, for example, friction welding.

The air distributor includes an additional channel which opens into the flow channel for the combustion air. Through the additional channel an additional gas which mixes in the flow channel with the combustion air can be introduced. The additional gas can be, for example, vented gases from the fuel tank of the internal combustion engine, blow-by gases from the crankcase of the internal combustion engine, or exhaust gases which are recirculated through an exhaust gas recirculation device from the exhaust gas manifold as a partial flow. The additional gas is introduced through the additional channel into the flow channel for the combustion air.

In the air distributor according to the invention, the additional channel is formed by a gap which is positioned between two housing parts of the air distributor. This embodiment has the advantage that two housing parts of the air distributor must be merely positioned and fastened relative to each other such that an intermediate gap is formed which is in flow communication with the flow channel for the combustion air. In contrast, it is not necessary to introduce an additional channel within a housing part so that technical simplifications result. In particular in case that the housing parts are produced by injection molding of plastic material, the tool for the housing parts is simplified because additional tools such as sliders can be dispensed with which are necessary otherwise for producing channels in injection-molded components.

Moreover, the gap between the housing parts has the advantage that in case of a connection of the housing parts by way of welding, in particular by way of friction welding, a relative movement is necessary between the housing parts; this is facilitated by the intermediate gap. All in all, the contact surface between the housing parts decreases on account of the gap so that reduced forces are required for the vibration movement of a housing part in order to carry out friction welding. Only outside of the gap the housing parts are contacting each other; in this contact area the friction welding connection is realized.

A good mixing action of the introduced additional gas with the combustion gas is effected by an elongate opening surface area of a narrow gap approximately transverse to the flow direction of the combustion gas.

In an expedient embodiment, the housing parts between which the gap is arranged include each an angularly extending flange relative to the longitudinal axis of the flow channel and the flanges are arranged neighboring each other and at a spacing to each other and the gap or additional channel extends between the two flanges. The flanges are formed, for example, by a radial outwardly oriented collar on the housing parts. The angle at which a flange extends relative to the longitudinal axis of the flow channel is within an angular range greater than 0° to maximally 90°. The flange faces that are facing each other and between which the gap is located extend preferably parallel.

According to another advantageous embodiment, in the mouth area that is opening into the flow channel the gap extends in circumferential direction, approximately transverse to the flow direction of the combustion gas relative to the longitudinal axis of the flow channel, across a greater angular range, for example, of at least 90°. If necessary, the gap extends across an angular range up to 180° or roughly 180° in the mouth area that is opening into the flow channel. This embodiment has the advantage that the mouth area between additional channel and flow channel extends about a relatively large distribution area by which the mixing action of the additional gas with the combustion air is improved in the flow channel. According to a preferred embodiment, the mouth area is embodied in a circular arc shape.

According to another expedient embodiment, an adjustable throttle valve, by means of which the combustion air flow in the flow channel is adjustable, is integrated into the air distributor. The additional channel opens preferably downstream of the throttle valve into the flow channel. Nevertheless, embodiments are also conceivable in which the additional channel opens upstream of the throttle valve into the flow channel.

The additional channel is preferably straight or embodied with a flat surface. It can be expedient that the additional channel consists of at least two channel sections that are straight or have a flat surface, but are angularly positioned relative to each other. In an alternative embodiment the additional channel includes at least one curved channel section which either lies in a plane or is bent in space.

The contact section where the housing parts are connected with each other is positioned at a distance relative to the additional channel. It can be expedient to arrange contact flanges on at least one housing part, if necessary both housing parts, which are positioned at an angle relative to the plane or to the longitudinal extension of the additional channel. When the additional channel is positioned between two flanges at the housing parts, the contact flanges extend at an angle to these flanges delimiting the additional channel. For example, the flanges delimiting the additional channel extend in radial direction to the longitudinal axis of the flow channel and the contact flanges extend orthogonally to these flanges and extend therefore again at least roughly in parallel with the longitudinal axis of the flow channel. In any case, it is expedient that the contact flanges extend at an angle relative to the additional channel which is greater than 0° and amounts to maximally 90°.

According to an advantageous embodiment, a housing socket with a socket channel introduced therein is formed in a housing part and is in flow communication with the additional channel. The socket channel in the housing socket opens into the additional channel between two housing parts. A conduit, for example, a hose, through which the additional gas is introduced into the air distributor can be connected to the housing socket.

The additional channel opens with an angular range between 0° and 90° into the flow channel. According to a first advantageous embodiment, the angle is 90°. In a second advantageous embodiment the additional channel extends adjacent to the mouth area in parallel with the longitudinal axis of the flow channel and the flow channel in the mouth area advantageously widens radially.

Geometric relations of channels or housing parts can vary in accordance with the respectively considered cross-sections through the component. Component edges and channel orientations are matched advantageously to the mold removal directions of the component, in particular in case of plastic components which are produced by injection molding.

### BRIEF DESCRIPTION OF THE DRAWINGS

Further advantages and expedient embodiments can be taken from the further claims, the description, and the drawings.

In the Figures, a component is shown that in reality is curved or bent in space in a complex manner. The section illustrations are greatly simplified for a better understanding thereof.

FIG. 1 shows a perspective view of an air distributor for an internal combustion engine.

FIG. 2 is in enlarged individual illustration of the air distributor with the mouth area of an additional channel that is opening into a flow channel for the combustion air to be supplied.

FIG. 3 shows the air distributor in a longitudinal section with two housing parts between which a gap is positioned which forms the additional channel.

FIG. 4 shows the air distributor in an embodiment variant.

FIG. 5 is a further embodiment variant of the air distributor.

In the Figures, the same components are provided with the same reference characters.

### DESCRIPTION OF THE INVENTION

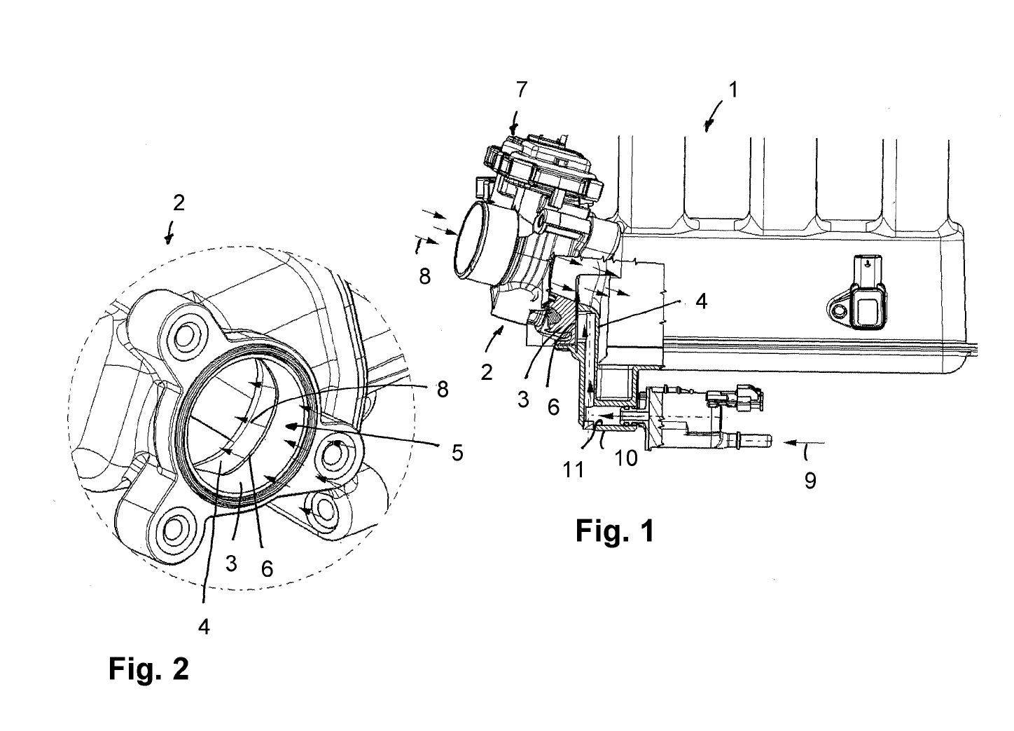

In FIG. 1 in connection with FIG. 2, an intake manifold 1 for an internal combustion engine with an air distributor 2 is shown through which combustion air can be supplied to the cylinders of the internal combustion engine. An adjustable throttle valve 7 by means of which the combustion air flow is variable adjustable is integrated into the air distributor 2. The combustion air is guided according to the flow arrows 8 through the air distributor 2.

The combustion air flows through a flow channel 5 in the air distributor 2 which is radially delimited at least in sections thereof by two housing parts 3 and 4 of the air distributor. The housing parts 3 and 4 are made of plastic material and are connected, for example, by friction welding, with each other. Between both housing parts 3 and 4, a gap 6 is formed in the area of the flow channel and opens into the flow channel 5 in radial direction. The gap 6 forms an additional channel through which an additional gas can be additionally introduced into the flow channel 5. The additional gas is introduced, as indicated by the flow arrows 9, through a housing socket 10 into the air distributor 2, wherein the socket channel 11 in the housing socket 10 is in flow communication with the gap 6 between the housing parts 3 and 4 so that the additional gas through the socket channel 11 and the gap or additional channel 6 can flow into the flow channel 5 and can mix with the combustion air in the flow channel. The additional gas can be, for example, vented gases of a fuel tank of the internal combustion engine; however, other additional gases are also conceivable, as, for example, blow-by gases from the crankcase of the internal combustion engine or exhaust gases of an exhaust gas recirculation.

As can be taken from the enlarged perspective illustration according to FIG. 2, the mouth area of the additional channel 6, positioned between the neighboring housing parts 3 and 4, extends about an angular range of approx. 180° relative to the longitudinal axis of the flow channel 5 in a plane transverse to the flow direction. Accordingly, the additional gas can flow across a relatively large distribution surface area into the flow channel 5 and mix evenly with the combustion air.

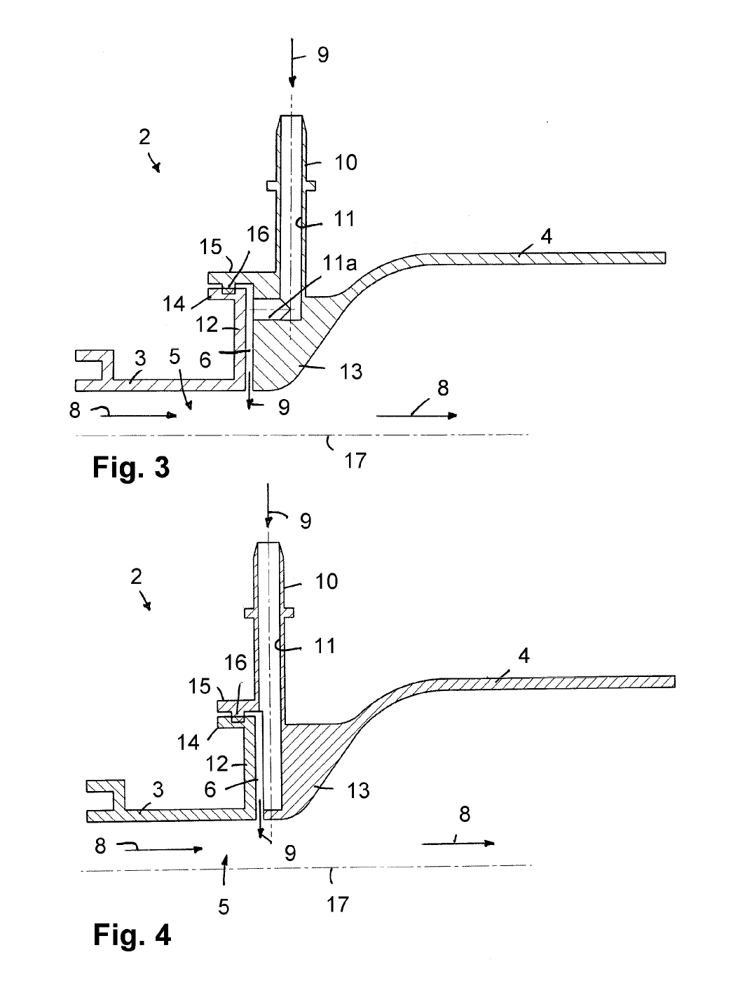

In FIGS. 3 to 5, different embodiment variants of the air distributor 2 with the additional channel 6 between the housing parts 3 and 4 are shown. According to FIG. 3, a flange 12 or 13 extends in radial direction, respectively, radial relative to the longitudinal axis 17 of the flow channel 5, on both housing parts 3 and 4, which adjoin each other in the mouth area of the additional channel 6 in direction of the longitudinal axis 17, wherein the flange faces of the flanges 12, 13 that are facing each other extend parallel and are positioned at a distance to each other. In this way, the intermediate gap 6 is formed which has the function of an additional channel and opens in radial direction and thus approximately orthogonally to the longitudinal axis 17 into the flow channel 5.

The additional channel 6 through which, according to the flow arrows 9, the additional gas is guided is in flow communication with upstream housing socket 10 or the socket channel 11 arranged therein, wherein a conduit for the supply of the additional gas can be connected to the housing socket 10. The socket channel 11 in the housing socket 10 extends in this embodiment approximately parallel displaced relative to the plane of the additional channel 6 which is positioned approximately orthogonal to the longitudinal axis 17. The connection between the socket channel 11 and the additional channel 6 occurs through a short channel section 11 a which is introduced into the housing part 4 and extends parallel with the longitudinal axis 17. The housing socket 10 is embodied in the shown embodiment monolithic with the housing part 4.

A monolithically embodied contact flange 14 or 15 extends at right angles to the flanges 12 and 13 on the housing parts 3 or 4, respectively. Between the contact flanges 14 and 15, there is a contact section 16 which is embodied in an exemplary fashion as a projection on the contact flange 15 and contacts the opposite contact flange 14. In the area of this contact section 16, the fixed connection between both housing parts 3 and 4, in particular by way of friction welding, is realized.

The gap extension of the additional channel 6 in the direction of the longitudinal axis 17 is relatively small; it is smaller than the diameter of the socket channel 11 in the housing socket 10.

In the embodiment variant according to FIG. 4, the air distributor 2 is substantially the same as in the embodiment of FIG. 3. Nevertheless, the embodiment of housing socket 10 and additional channel 6 is different because according to FIG. 4 the side of the air channel 6 which is facing the flange 13 on the housing part 4 is formed immediately by the socket channel 11 in the housing socket 10. In contrast to FIG. 3, in FIG. 4 a channel section 11a is missing which is directed, for example, in parallel with the longitudinal axis 17 and is introduced into the housing part 4. In the embodiment according to FIG. 4, the socket channel 11 is embodied in the housing socket 10 so as to be extended in radial direction toward the longitudinal axis 17 and end shortly before the flow channel 5 so that the additional channel 6 has a greater expansion in the area of the extended socket channel 11. All together, the embodiment according to FIG. 4 provides for a facilitated flow transfer of the additional gas from the socket channel 11 into the additional channel 6. Moreover, the housing part 4 can be produced more easily because the additional channel section 11 a is dispensed with.

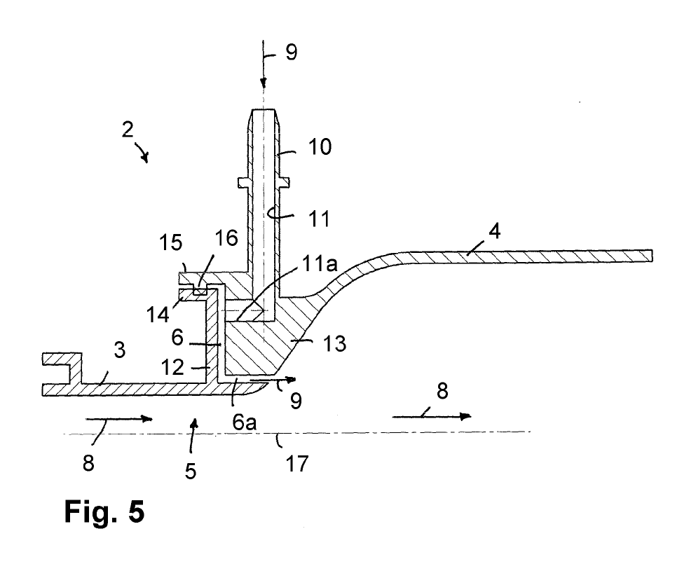

In FIG. 5, another embodiment variant is illustrated which is embodied substantially in the same way as the embodiment according to FIG. 3 and provided, like the latter, with a channel section 11 a extending parallel relative to the longitudinal axis 17 for flow communication between the socket channel 11 in the housing socket 10 and the additional channel 6. In FIG. 5, the additional channel 6 is embodied angularly and includes, in addition to the channel section which extends approximately radially relative to the longitudinal axis 17 of the flow channel 5, another channel section 6a which opens into the flow channel 5. The channel section 6a extends approximately in parallel with the longitudinal axis 17 of the flow channel 5 and is positioned at an angle to the channel section which extends parallel to the socket channel 11 in the housing socket 10.

While specific embodiments of the invention have been shown and described in detail to illustrate the inventive principles, it will be understood that the invention may be embodied otherwise without departing from such principles.

What is claimed is:

1. An air distributor for an internal combustion engine, the air distributor comprising:
at least two housing parts;
a flow channel for combustion air extending through the at least two housing parts;
an additional channel for an additional gas opening into the flow channel, wherein the additional channel is formed by a gap between the at least two housing parts.

2. The air distributor according to claim 1, wherein the at least two housing parts each comprise a flange angularly extending relative to a longitudinal axis of the flow channel, wherein the flanges are arranged adjacent to each other, and wherein the additional channel extends between the flanges.

3. The air distributor according to claim 1, wherein a mouth area of the additional channel opening into the flow channel comprises a curved shape.

4. The air distributor according to claim 3, wherein the curved shape is a circular arc shape.

5. The air distributor according to claim 3, wherein the mouth area of the additional channel opening into the flow channel extends across an angular range of at least 90°.

6. The air distributor according to claim 1, wherein the additional channel is comprised of at least two channel sections, wherein the channel sections each are straight but arranged angularly relative to each other.

7. The air distributor according to claim 1, wherein the at least two housing parts are joined at a contact section that is arranged at a spacing relative to the additional channel.

8. The air distributor according to claim 7, wherein the at least two housing parts comprise contact flanges forming the contact section, wherein the contact flanges are positioned angularly relative to the additional channel.

9. The air distributor according to claim 1, further comprising a housing socket with a socket channel extending therethrough, wherein the additional channel is in flow communication with the socket channel, wherein the housing socket is monolithic with one of the at least two housing parts.

10. The air distributor according to claim 1, wherein the additional channel opens approximately parallel with a longitudinal axis of the flow channel into the flow channel.

11. An internal combustion engine comprising an air distributor according to claim 1.
